(19) United States
(12) Patent Application Publication
(10) Pub. No.: US 2014/0008545 A1
(43) Pub. Date: Jan. 9, 2014

(54) METHODS, APPARATUS AND COMPOSITIONS FOR DIFFUSING AND MITIGATING LASER ENERGY, INFRARED ENERGY AND ELECTRON BEAMS

(71) Applicant: Stephen George Opuszynski, Portland, CT (US)

(72) Inventor: Stephen George Opuszynski, Portland, CT (US)

(21) Appl. No.: 13/593,504

(22) Filed: Aug. 23, 2012

Related U.S. Application Data
(60) Provisional application No. 61/669,000, filed on Jul. 6, 2012.

(51) Int. Cl. G02B 5/02; H01J 3/14; F21V 33/00; G21K 5/04; B32B 5/16; F21V 5/00

(52) U.S. Cl. 250/396 R; 252/582; 428/220; 362/259; 362/101; 250/504 R; 250/435

(57) ABSTRACT

A water soluble composition mitigates and diffuses energy, such as laser energy, infrared energy and electron beams with minimum backing height.

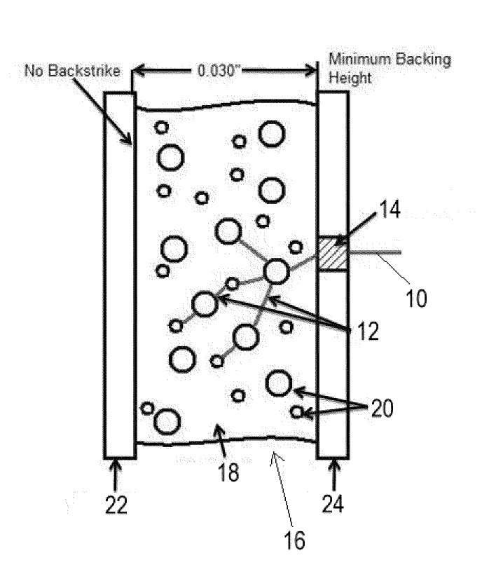

The composition of the present invention presents no environmental hazard or residual liability of waste or byproducts.

### CROSS-REFERENCE TO RELATED APPLICATIONS

This application claims the benefit of of U.S. provisional patent application No. 61/669,000, filed Jul. 6, 2012, the contents of which are herein incorporated by reference.

### BACKGROUND OF THE INVENTION

The present invention relates to energy diffusing and mitigating apparatus and methods and more particularly, to methods and apparatus for diffusing and mitigating laser energy, infrared energy and electron beams in, for example, a backing height of less than 0.030 inch with a water soluble slurry.

Laser energy deployed in cutting, drilling, welding, and other applications has always had the challenge/constraint of catching the “back-strike” after break through. This area has to be protected.

Current technology catches the beam after break through and requires a minimum backing height of 0.125 inch or greater occupied space with high cost.

Coppers and polymers are used to absorb the beam. This technology requires costly, limited-life materials along with time-consuming and costly installation and retraction. Further, because of the large backing height, there is a constraint in application with this current design.

As can be seen, there is a need for an improved method and apparatus for diffusing and mitigating laser energy, infrared energy and electron beams that is easy to use, cost effective and environmentally friendly.

### SUMMARY OF THE INVENTION

In one aspect of the present invention, a composition for diffusing beam energy to prevent back-strike comprises a binding material that solidifies in atmosphere and is water soluble; and a population of prisms including a plurality of glass spheres.

In another aspect of the present invention, a method for the mitigation of energy comprises directing the energy into a composition having a plurality of glass spheres disposed in a binding material, the binding material being water soluble and operable to solidify in atmosphere; and diffusing the energy as it passes through the glass spheres.

These and other features, aspects and advantages of the present invention will become better understood with reference to the following drawings, description and claims.

### BRIEF DESCRIPTION OF THE DRAWING

The Figure is a cross-sectional view of an energy diffusing apparatus according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a water soluble composition to mitigate and diffuse laser energy, infrared energy and electron beams with minimum backing height. The composition of the present invention presents no environmental hazard or residual liability of waste or byproducts.

The composition of the present invention is a solution that solidifies in atmosphere (standard sea-level atmospheric pressure), maintaining a specific suspended matrix of spheres (spherical medium) in place, such that energy entering the composition is diffused through countless prisms. The composition of the present invention is also environmentally safe, as the composition can be dissolved in tap water, leaving the spheres collectable for reuse. The composition can enter a confined space as a liquid, and takes on the exact shape of its constraining members, leaving zero space with shrinkage. The composition of the present invention has proven successful in multi-shoot YAG laser drilling of high temperature alloys in aerospace components with no side effects. Exemplary results have been achieved in drilling cooling holes (0.025 inch diameter) into turbine blades, vanes and exhaust liners for MRO and OEM components.

The composition of the present invention could be used in various fields of technology, including, but not limited to, healthcare, transportation, national security, space and aviation. Applications designed for specific use are endless, but can include adhesion, suspension, encapsulation, infusion, injection, bonding and lamination.

The composition could be developed into various forms such as, but not limited to: tape, ribbon, paste, pouch, gelatin, slurry, bricks and many other configurations, making applications in business, industry, health care, space exploration, and defense endless. Further modifications in size, shape, thickness and sphere and matrix composition can provide improved quality and sensitivity of the composition of the present invention, opening more doors in high energy mitigation. The composition of the present invention could include military uses, making laser and infrared targeting/tracking devices obsolete. The composition of the present invention can be used for the distortion of heat signatures of aircraft, increased cooling holes to space shuttle heat shields, health care x-ray exposures. Further applications can be realized in automotive, appliance, and computer industries, where laser accuracy/utilization was handicapped by the inability to stop the beam.

The composition 16 of the present invention includes two main elements—a liquid bonding agent 18 and a population of prisms 20. The number, concentration, size and indifferent mixture of prisms 20 are secured in suspension by the solidification of the bonding agent 18. The prisms 20 serve only to diffuse the energy and are released when the bonding agent 18 is introduced to water or solvent. The composition 16 could be disposed between two components 22, 24, such as in a confined space. No backstrike is typically needed with the energy diffusing composition 16 of the present invention. In some embodiments, as shown in the figure, the energy 10 can pass through an opening 14 to meet the composition 16 of the present invention. The prisms 20 can cause the energy 10 to diffuse, as shown by lines 12. While the Figure shows a backing height of about 0.030 inch, various backing heights can be used depending on the specific application.

The bonding agent is a multi-part solution that solidifies in atmosphere (standard sea-level atmospheric pressure and temperature) in just a short amount of time. This composition is water soluble, aiding in removal and clean operation. The prisms are glass spheres of specific diameters in varied combinations of effective matrix. The diffusing spheres are bonded in predetermined concentrations, configurations in a homogeneous suspension in the bonding agent.

Current methods “catch” the beam. The composition of the present invention “diffuses” and mitigates the energy beam. Current efforts are effective only to 0.080 inch backing height, limiting laser applications in many industries worldwide. The composition of the present invention enhances this constraint by about 70%, opening the door to laser drilling areas and materials deemed impossible with current knowledge and materials. Current methods of “catching” the energy in blocks of copper tungsten or poly materials requires sheets, blocks, injections or wax to be utilized in back-strike mitigation. This results in costly and time consuming cleanup. The composition of the present invention diffuses the energy, as opposed to catching the beam in a reusable medium. The composition of the present invention has proven to diffuse laser beam energy during operation and prevent back-strike in shallow backing heights of a mere 0.030 inch.

It should be understood, of course, that the foregoing relates to exemplary embodiments of the invention and that modifications may be made without departing from the spirit and scope of the invention as set forth in the following claims.

What is claimed is:

1. A composition for diffusing beam energy to prevent back-strike, the composition comprising:
a binding material that solidifies in atmosphere and is water soluble; and
a population of prisms including a plurality of glass spheres.

2. The composition of claim 1, wherein the glass spheres are borosilicate glass.

3. The composition of claim 1, wherein the composition has a thickness of less than 0.030 inch.

4. The composition of claim 1, wherein the composition is provided as one of a tape, ribbon, paste, pouch, gelatin, slurry, or brick.

5. The composition of claim 1, wherein the glass spheres for a homogeneous mixture in the binding material.

6. A method for the mitigation of energy, comprising:
directing the energy into a composition having a plurality of glass spheres disposed in a binding material, the binding material being water soluble and operable to solidify in atmosphere; and
diffusing the energy as it passes through the glass spheres.

7. The method of claim 6, further comprising delivering the composition in a liquid form into a confined space.

8. The method of claim 6, further comprising collecting and reusing the glass spheres after use by dissolving the binding material with water and filtering the glass spheres for reuse.
